(19) United States
(12) Patent Application Publication
(10) Pub. No.: US 2021/0264445 A1
(43) Pub. Date: Aug. 26, 2021

(54) SYSTEM, DEVICE AND METHOD FOR TOKEN GENERATION AND USE

(71) Applicant: SITA INFORMATION NETWORKING COMPUTING USA, INC., Atlanta, GA (US)

(72) Inventors: David AXELROD, Singapore (SG); Jeffrey Michael COTTERILL, North Sydney (AU)

(21) Appl. No.: 17/251,644

(22) PCT Filed: Jun. 27, 2019
(86) PCT No.: PCT/IB2019/055471

§ 371 Date: Dec. 11, 2020

(30) Foreign Application Priority Data
Jun. 29, 2018 (GB) 1810744.1

(51) Int. Cl. G06Q 30/00; G06K 19/06; G06Q 50/28; G06K 1/12; G06K 7/14; G06Q 50/14; G06Q 10/02; B64F 1/36

(52) U.S. Cl. CPC G06Q 30/0185; G06K 19/06037; G06Q 50/28; G06K 19/06028; G06K 2007/10504; G06K 7/1413; G06Q 50/14; G06Q 10/02; B64F 1/366; G06K 1/121

(57) ABSTRACT

A token (100, 703, 705, 707) for use with an item handling system (109) is provided herein. The token can be encoded with data. The data can define a further second token (801), wherein the data comprises an identifier associated with an item. The identifier can be associated with the item for processing by the item handling system.

### FIELD OF THE INVENTION

This invention relates to a system, apparatus, method or computer program for generating a token such as a descriptive identity tag. In particular, but not exclusively, this invention relates to a system, apparatus, and method for producing a descriptive identity tag associated with an item of baggage which may be processed at airports, seaports, railways, and other mass transport locations with an item handling system. Even more particularly, this invention relates to a system, apparatus and method for generating a bag tag or other descriptive identity tag, which may be registered in one or more registries for the purpose of identification, delivery control and tracking. Further, this invention relates to an improved system, device and method for applying tags at an airport as well as to the issuance of bag tags to airline customers.

### BACKGROUND OF THE INVENTION

Customer self-service has been embraced by the majority of airlines and established itself as the method of choice for passenger check-in. Self-service functionality is usually performed using self-service kiosks located at an airport, point of departure or in-conjunction-with mobile and internet connected devices in customers' possession.

In the past, self-check-in kiosks only issued boarding passes. Today however, most kiosks support self-tagging as well. This was made possible by the addition of necessary features into airline Departure Control System (DCS) or related applications. Common-use self-service kiosks have also been used where kiosk functionality is provided such that the kiosks can be shared by a number of different airlines. Such kiosks offer economy of scale through dynamic sharing by multiple airlines. However, they suffer from a number of problems. For example, the cohabitation of applications sourced from different vendors can usually only be achieved through strict and complicated standardisation which leads to higher costs associated with such shared kiosks.

The issuance of boarding passes is increasingly handled by customers' devices. Kiosks, however, remain the only practical way for self-tagging. This is because the printing of bag tags requires specialized equipment and special paper stock. Numerous attempts have been made to implement print-at-home bag-tags and permanent bag-tags, but none of these solutions have been particularly successful.

Therefore, self-service kiosks have remained one of the more popular solutions at airports to print bag tags if manual issuance of bag tags at attended check-in counters is to be avoided.

The inventors have appreciated that there is a need to provide an improved class of applications for use with a kiosk, as well as an improved kiosk which is quicker and easier to use, and which is functionally simpler than the shared kiosks mentioned above.

### SUMMARY OF THE INVENTION

Embodiments of the invention seek to address the above problems by providing a token for use with an item handling system, wherein the token is encoded with data defining one or more further tokens or tags. Usually, further tokens or tags are subsequently generated by the item handling system based on the data encoded within the token.

One benefit associated with embodiments of the invention is that the processing time taken to produce the further token or tokens from the token is greatly reduced. Thus, embodiments of the invention may allow for quicker and simpler operation of kiosks by users or passengers. This means that the passenger processing rate is substantially improved compared to conventional kiosks. A kiosk may be thought of a stand which is usually associated with, or comprises a computer processing device for the provision of goods or services.

For example, conventional systems usually take about 60 seconds to generate 3 tags, whereas by processing the claimed token the 3 tags or further tokens may be generated in about 5 seconds. This represents a significant 12-fold increase in the speed with which the further tokens may be generated. This has particular application in the aviation industry where the passenger processing rate is crucial, otherwise this can lead to delays.

Embodiments of the invention may provide a kiosk or user terminal, or other computing device for token processing. Preferably the kiosk comprises a token reader and a printer.

Embodiments of the invention may include functional components referred to as a Logical Issuance Set Logical Issuance Set. Usually, the Logical Issuance Set is embodied in a computing device, such as a portable or mobile communications device, a portable laptop computer or other computer system or server other user device 113. The Logical Issuance Set is usually a constituent of a check in system, such as a web-check in system.

The device 113 may comprise a user interface which allows a user to interact with a DCS.

A Physical Printing Set, PPS functional component may also be defined. This is usually referred to as a kiosk 102 or device for processing bag tags. Usually, the device or kiosk 102 comprises a scanner or reader and a printer.

The kiosk 102 may have the function of data validation of data and producing tangible artefacts (e.g. tags). The kiosk 102 are usually relatively inexpensive to manufacture and deploy and easy to support. The kiosks are also usually generic in nature, i.e. usable by customers of multiple business entities. Further the kiosk is usually clearly visible and identifiable.

Finally, embodiments of the invention may use a Data Delivery Set, DDS which provides a link between the Logical Issuance Set and kiosk 102.

Each relevant business entity, such as an airline, may control its own implementation of the Logical Issuance Set and be able to change or customize the Logical Issuance Set without affecting the kiosk 102 and DDS used or supplied by other parties.

Embodiments of the invention may delimit the DDS into a separate entity. By decoupling the Logical Issuance Set and the kiosk 102, each of the latter two sets of operational functions can be performed when and where needed.

Embodiments of the invention have the potential capacity to deliver complete and self-sufficient sets of data through the DDS. This eliminates the need for direct interaction between the kiosk 102 which uses the DDS data to print a bag tag and any back-end applications, such as a departure control system. Thus, the kiosk may be able to independently generate the further tokens without communicating with the departure control system. This may be achieved by using the data in the token 100 and the predefined PECTAB format and checksum identifier stored on the kiosk. Accordingly, the data delivery set or token 100 is usually encoded with all data to allow standalone printing of further tokens without communicating with baggage systems. The computing device or kiosk 102 may only need to supply or in other words store a particular PECTAB format for each airline, the logo of airline, and the secret code for signature of check sum which may be compared to data encoded within the token.

This approach does not require significant changes to the Departure Control System (DCS) applications. It can also be applied without affecting other aspects of customer service process.

Embodiments of the invention allow passengers to utilise unattended service positions or Kiosks, which may, in principle be provided at any location, and not simply at an airport, to request and obtain bag-tags for their check-in luggage.

Embodiments of the invention allow for a dramatic reduction in the number of hardware components, software business application components and software operating system components which need to be provided at a kiosk. This is because the kiosk no longer needs to communication with a back-end systems such as a departure control system in order to generate a tag or tags.

Embodiments of the invention have the following further advantages:
Reduced cost of application development;
Minimized floor-space requirements in the concourse;
Economy of IT infrastructure expenses; and
Reduced cost of support and maintenance.

According to an aspect of the present invention, a method for reading data from a token for use with an item handling system is provided in which the method comprises reading, from the token, data defining a further second token wherein the data comprises an identifier associated with an item for processing by the item handling system; and generating a second token based on the data read from the token.

According to a further aspect of the present invention a method for generating data for generating a token for use with an item handling system is provided in which the data defines a further second token wherein the method comprises determining data associated with the second token, the data comprising an identifier associated with the item for processing by the item handling system; and determining data defining the number of further tokens.

According to a further aspect of the present invention a method is provided to determine user data associated with a record in a computerised reservation system; transmit the user data to the computerised reservation system; and receive data defining a token for use with an item handling system wherein the data comprises data defining a further second token.

### BRIEF DESCRIPTION OF THE DRAWINGS

An embodiment of the invention will now be described, by way of example only, and with reference to the accompanying drawings, in which:

FIG. 1 is a schematic diagram of the main functional components embodying the invention;

FIG. 2 is a swim lane diagram showing how some of the components embodying the invention interact with each other;

FIG. 3 shows a number of exemplary tokens embodying the invention; and

FIG. 4 shows a number of exemplary further tokens embodying the invention which may be generated from the tokens shown in FIG. 3.

### DETAILED DESCRIPTION

The following exemplary description is based on a system, apparatus, and method for use in the aviation industry. However, it will be appreciated that the invention may find application outside the aviation industry and in any industry, such as in the packaging or delivery industry where certain data is encoded into a token and where the encoding of the data into the token relies on obtaining data from a number of different sources such as a remote departure control system as well as information provided by a user such as passenger to a local kiosk or user terminal. Further, the invention may find application in any industry where tokens are issued. Thus, embodiments of the invention find application in the travel industry in general, such as rail, coach, car, as well for delivery and courier services where tokens may be used.

Additionally, the following embodiments described may be implemented using a C++ programming language using for example an OpenCV library. However, this is exemplary and other programming languages known to the skilled person may be used such as JAVA.

System Operation

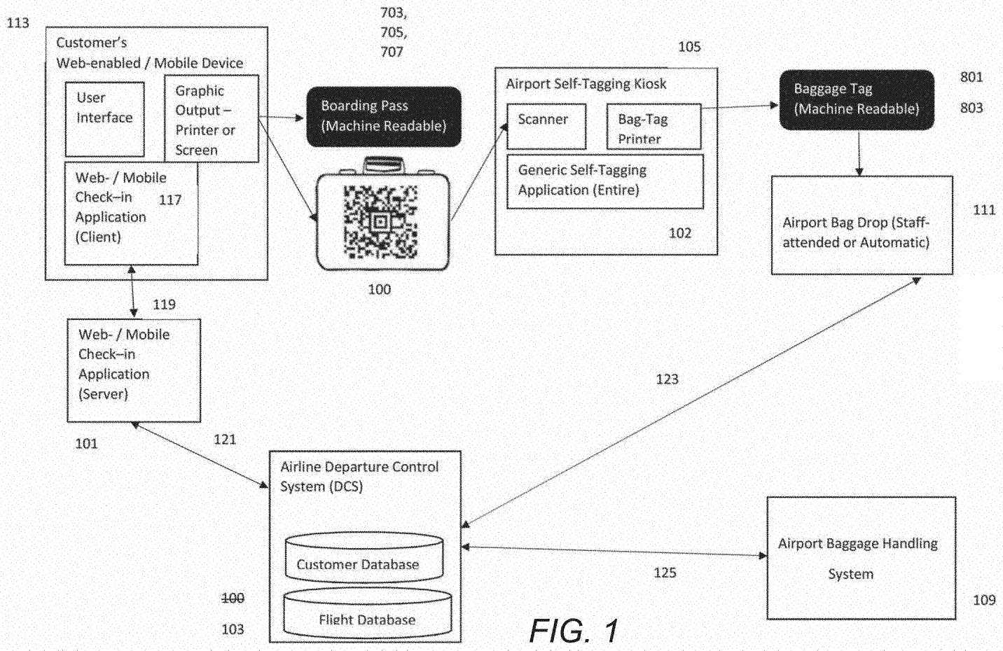

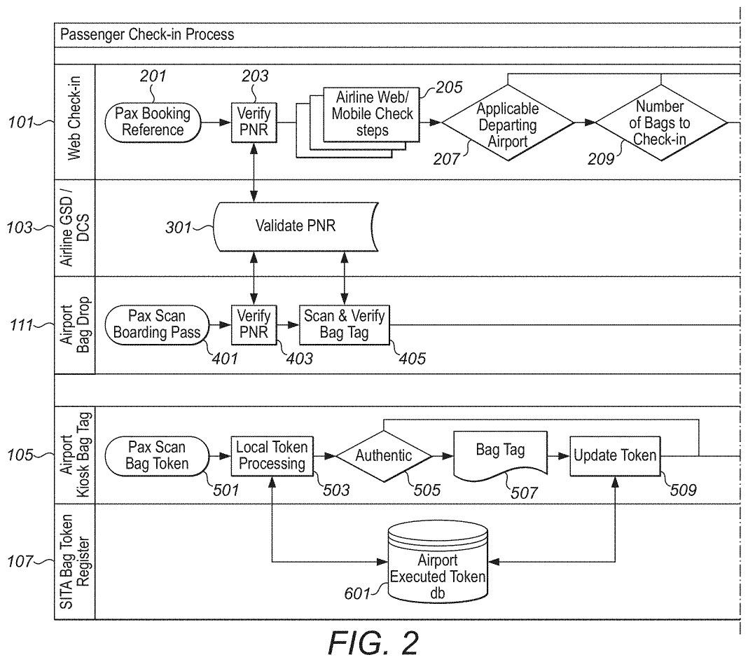

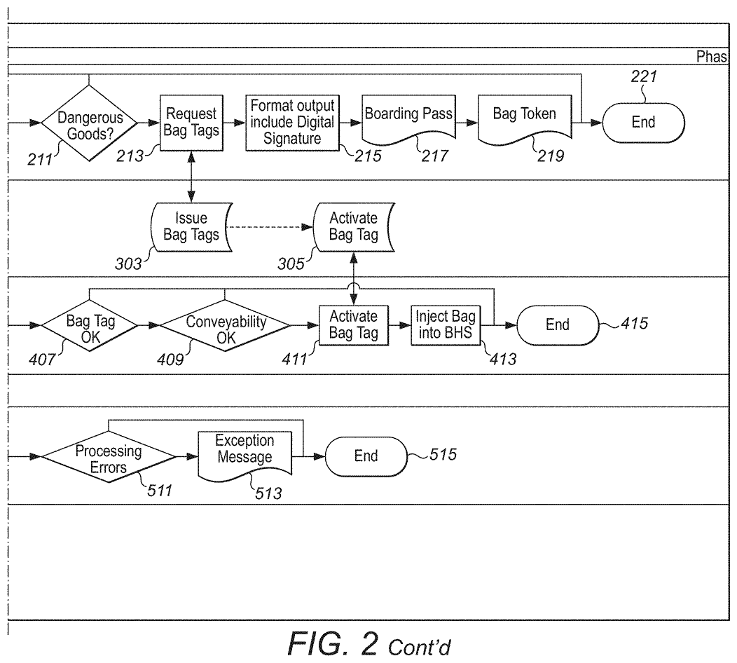

An embodiment of the invention will now be described referring to the functional component diagram of FIG. 1 which shows the system as a whole, also referring to the swim lane diagram of FIG. 2 which shows how various different components of the system interact with each other. However, from the following description, it will be clear that embodiments of the invention may reside in any one of the functional components shown in FIG. 1 or as the system as a whole.

Usually, the messaging or communication between the different functional components in these figures are performed by way of REST\JSON API calls. These may be communicated over HTTPS using wired or wireless communications protocols as previously described.

Usually, each of the different functional components shown in FIG. 1 may communicate with each other, using wired or wireless communication protocols which will be known to the skilled person. The protocols may transmit service calls, and hence data or information between these components. Data within the calls is usually an alpha-numeric string which is communicate using wired or wireless communication protocols which will be known to the skilled person.

With reference to baggage handling systems for the aviation industry, the overall purpose of baggage tagging is to provide the Airport Baggage Handling Systems (BHS) with the means to distinguish individual baggage items and with information sufficient for the accurate loading, unloading, routing and tracking of the said items from the point of origin to the ultimate destination of the journey.

This may be achieved a combination of any one or more of:
1. Equipping each baggage item with a unique identity badge in the form of a resilient Bag Tag carrying human readable descriptions of the owner and of the journey and a machine-readable unique identifying number, known as a License Plate Number (LPN);
2. Electronic delivery of the information relevant to each LPN, including any possible dynamic updates, from the Airline Departure Control Systems (DCS) 103 to BHS 109 in all airports, where the baggage item is be loaded, unloaded, transferred between flights or otherwise handled.

The system may comprise any one or more of an application 117, such as a web check-in application which may run on a mobile or portable communication device 113 or laptop, a check-in server, 101, a departure control system 103, a kiosk 102, a bag token server 107 (not shown in FIG. 1), a baggage handling system 109, and a physical airport bag drop facility 111. Usually each of the check-in server 101, kiosk 102, departure control system 103, bag token server 107, and baggage handling system 109 run on a separate computer processor or server, although it will be appreciated that embodiments of the invention may in principle run on a single computer or server. Usually, a wired or wireless communications network is used. This may communicatively couple one or more of the functional components shown in FIG. 1 together to allow data exchange between the component(s).

The application 117 may comprise an API running on the device 113 such as a personal computer, portable computer or portable telephone or mobile device. The device 113 may comprise a web browser. The browser and device 113 allow for data to be communicated between different functional components, for example using wired or wireless communication protocols which will be known to the skilled person. The web browser or application 117 allows a user of the device such as a customer, passenger or agent to have access to the check-in computer or server 101 which supports an airlines web check-in functionality for example by way of the application including one or more application programming interfaces, API's.

Firstly, the functionality of the web check-in application 117 will be described. A user first launches the application 117 on the device 113. In response, a statefull session is established between the web check-in application 117, which may include one or more API's, and the check-in server 101 via the wired or wireless communications system or network 115. In this way, both the application 117 and the check-in server or application 101 is linked to, or associated with a particular session and hence with a particular passenger.

Usually, the passenger or user provides data which allows the airline check-in server to uniquely identify the passenger. Commonly, the passenger may enter data a booking reference, such as a PAX booking reference, or/and a passenger name into the application 101. The booking reference may also be referred to as a Passenger Name Record. Other examples of data which may be entered to identify a passenger is a frequent flyer reference. Usually, the data is defined by an alpha numeric string.

The application 117 then communicates this data to the check-in server 101. Thus, the server 101 receives the booking reference at step 201. The check-in server 101 then queries a database to determine, usually uniquely, a passenger name record associated with the booking reference. The database is usually part of, or associated with the check-in server 101. At step 203, the server 101 optionally verifies or validates the booking reference. Thus, it will be appreciated that the application 117 interacts with the airline's Departure Control System, usually via the web check-in server 101 in order to validate the booking reference. This may be performed by way of Web Services Description Language, WSDL, Simple Object Access Protocol (SOAP), or Extensible Markup Language, XML, or using a REST\JSON API call but other messaging protocols for exchanging structured information over a network will be known to the skilled person.

The verification or validation process may be performed by verifying a passenger name record associated with the PAX booking reference by querying a database. Usually the verification step is performed by communicating the PNR or received booking reference, to an airline Departure Control System 103. The airline Departure Control System may perform the verification in response to receiving the PNR associated with the customer or passenger. Usually, the received PNR is compared to one or more PNR's stored in a database. The database is usually stored in a memory such as a random access memory.

Check-in is performed by exchanging data, at step 205 between the check-in server 101 and the departure control system 103.

As part of the check in process, the Departure Control System, DCS 103 may retrieve data from the database. The data retrieved from the departure control system, DCS 103 as part of the check in may comprise data defining a customer as well as data defining a journey associated with the customer.

In one specific example, any one or more of the data fields shown in Table 1 below may be retrieved from the database. In all cases, the data retrieved from the database is usually an alpha-numeric string.

The data retrieved from the PNR database in the departure control system is usually stored in a local cache or memory associated with the airline web check in server 101 while additional check-in steps, such as steps 207, 209, 211 are performed.

The application 101 may perform an optional check to determine whether the enhanced bag token 100 is applicable to the journey, for example whether the necessary equipment is deployed at the port of departure, at step 207.

Using the application running on the device 113, the passenger indicates that he has one or more bags to check in at step 209. The passenger enters the particular number of bags to be checked in by entering a number such as 0, 1, 2 or 3. Usually, as part of the check in process, the passenger confirms that the bags to be checked in do not contain any dangerous goods at step 211, but this is optional.

Steps 207, 209, and 211 are performed by a passenger entering the relevant information or data using the application running on the passenger's device 113.

Once the passenger has entered all the necessary data in the application 117 running on the mobile device 113, the application sends a bag tag issue request to the departure control system 103. Usually, this is performed via the web-check in server 101.

In response to receiving the bag tag issue request, the check-in server 101 communicates the bag tag request message, at step 213 to the airline departure control system 103.

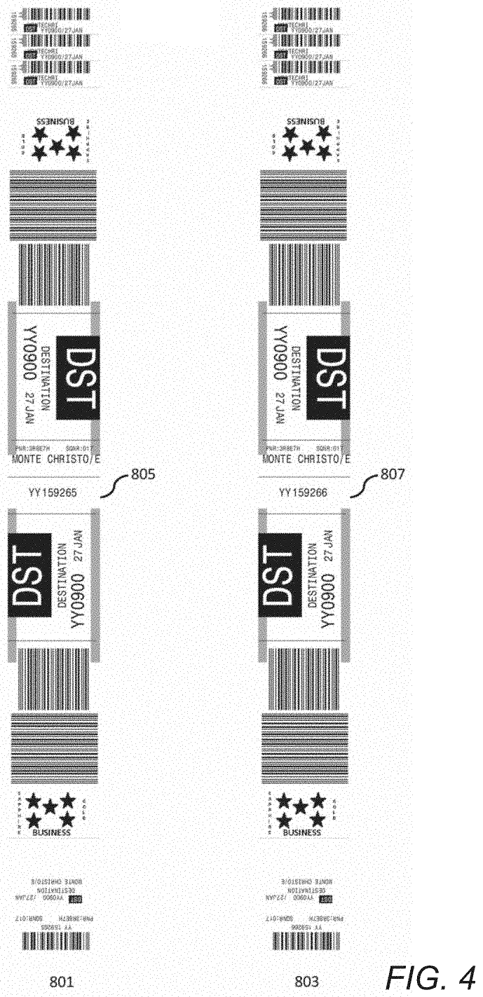

In response to receiving the bag tag request message, the airline departure control system 103 issues a bag tag at step 303. The step of issuing a bag tag may comprise assigning an identifier for each of the bags to be checked in. The bag identifier may be a unique bag identifier. The identifier is usually referred to as a Licence Plate Number, LPN and usually it is the departure control system which allocates the license plate number(s), LPN. The LPN may be a 12 digit alpha-numeric code, defined according to the IATA standard. The airline departure control system 103 then returns a data structure containing all elements needed for printing of the bag tag. For example, in addition to the licence plate number communicated to the web check-in server 101, further data is sent to the web check-in server 101. Thus, it will be appreciated that any one or more of the data elements shown in FIG. 4 of the drawings may be returned. For example, the data may comprise any one or more of data defining an origin or destination via one or more intermediate destinations. Thus, the bag tag may comprise data defining a single leg or multi-leg journey.

It is important to note that the data returned is not rendered images of the bag tag but structured records, which the Web/Mobile application server 101 can parse, at step 215.

The application 101 extracts the data and packages them in a compact format, such as that shown in Table 1. Besides the bag tag data, the resultant Bag Token string usually contains the meta-data and the digital signature which confirms that the Bag Token 100 has been generated by an authorized entity.

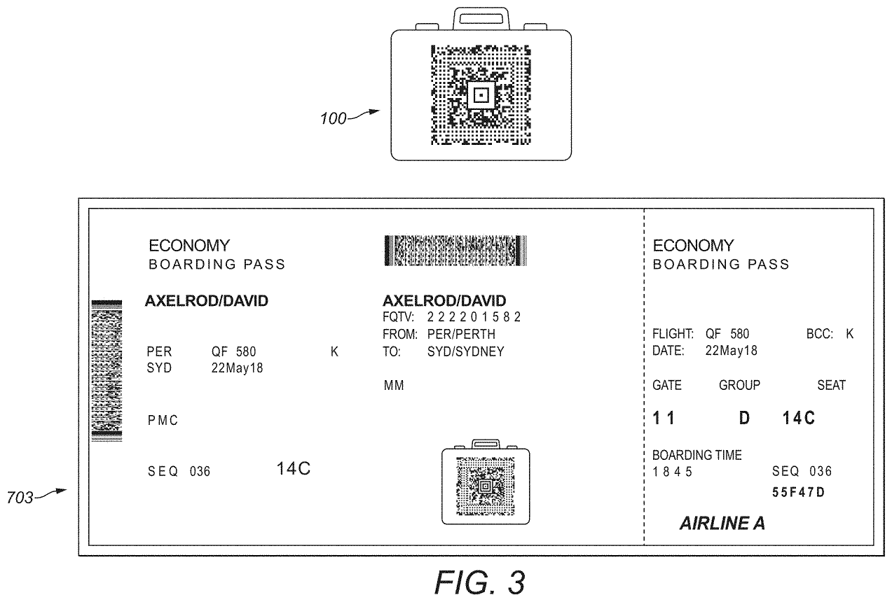

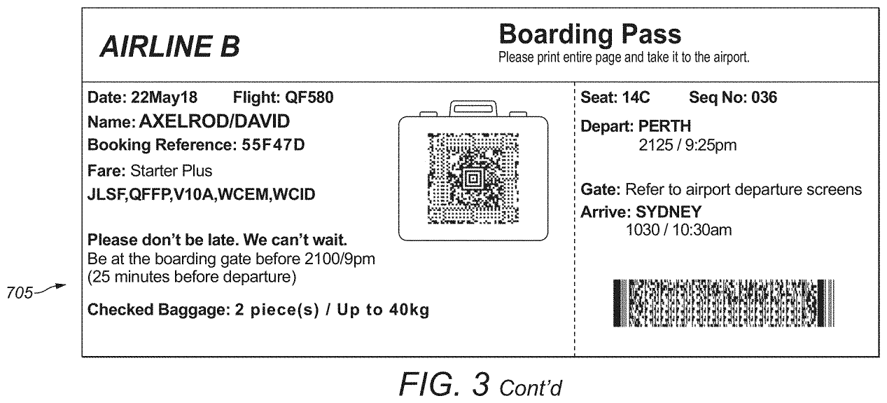

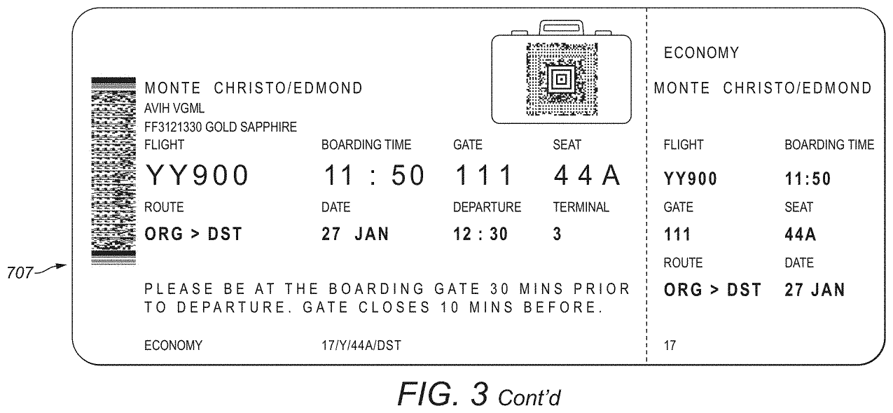

Usually, as part of the process, a boarding pass 703, 705, 707 is generated, at step 217. This may comprise any of the data shown in FIG. 3 of the drawings. However, at this stage of the process, the generation of the boarding pass at step 217 is optional, because it can be generated at a later point in the process. However, at step 219, the application 101 renders the Bag Token data in a Machine-Readable form, 100. For example, the machine readable form may be a 2D-barcode, an Near Field Communication, NFC message or format.

As described in further detail below, the data encoded in the token 100 may also be referred to a data delivery set, DDS.

The data encoded in token 100 may comprise defining a format associated with a further token, such as a bag tag, or/and the number of further tokens to be generated. The bag token 100 may be generated according to the format shown in FIG. 3. In this specific example data is encoded in a two dimensional grid using a number of symbols generated using black and white pixels or values. However, two-dimensional data encoding is optional and the data may be encoded using any format, such as 1-d barcodes, and so on.

Any of the tokens, such as the bag token 100, boarding pass token 703, 703, 707 or bag tag token 801, 8803 may be stored in a storage means associated with the device 113. In one specific example, the token 100 may be encoded into a boarding pass. This has the advantage that a passenger may optionally print the boarding pass and simply present the boarding pass for scanning at a kiosk for generation of the bag tag 801, 803 from the data encoded within the bag token 100.

The Bag Token 100 is then sent to the user's device 113 usually with a boarding pass 703, 705, 707. These may be issued to the customer along using a range of media, such as a document file; a printer; electronic mail, or electronic wallet. The process of generating the bag token 100 ends at step 221.

In addition to the steps described above, the airline departure control system 103 may optionally send a baggage message at step 305 to an airport bag drop device 111, which is usually coupled to the baggage system 109. The message informs the baggage system 109, and consequently the airport bag drop device which physically receives any bag that the tag is a valid bag tag.

In the embodiment shown in FIGS. 1 and 2 of the drawings, the step of generating a bag token 100 is performed at a remote computer or server 101. However, it will be appreciated that the bag token 100 generation functionality may be performed in any one of the functional components shown in FIG. 1 of the drawings or within the passenger's device using the application 113.

The following description provides an explanation of how the bag token 100 is processed at a kiosk 102 such as a bag tag printing kiosk, usually located in a bag drop area 105 located at an airport.

At step 501, the bag token 100 presented by a passenger, customer or user is scanned or read, usually, optically using a reader, such as a barcode reader or QR reader which may use known image processing algorithms to read the token 100. An .XML parser may be used to parse the data read from the token. Usually, the customer scans their bag token 100 at one of a variety of locations where bag tag printing facilities are available, such as at an airport kiosk, mobile ground handling tablet at airport, transport hub, on-board train, ferry, hotel, convention centre, holiday resort, and so on.

At step 503, local token processing is performed. This may comprising unpacking the data to extract specific data elements from all of the data encoded within the token 100. Usually, one or more of the data elements shown in Table 1 below is unpacked from the data read from the token 100.

As part of the local token processing 503, the kiosk 102 may check that the bag token 100 contains a valid information structure. In one example, the check may be performed by determining whether the data elements read from the token match the format of the data elements shown in Table 1 below.

Further, as part of the local token processing the kiosk 102 may check that the bag tag data encoded within the token 100 is or are intended for printing at a particular airport, and/or that date and/or time of travel encoded within the bag token matches the current date and/or time.

At step 505, an authentication step may be performed. This may comprise determining that a digital signature(s) encoded within the token match a predetermined signature which may be stored within a memory or storage means associated with the airport bag tag kiosk 102. This may allow the kiosk 102 to determine that the token has been generated by a party, such as an airline, who is authorised to generate a bag token. In other words, a validity check may be performed to determine whether the bag token 100 refers to an airline who has been configured to use the bag token.

Thus, the data read from the token 100 may be authenticated by reading a verification code, such as a 32-bit verification code which may be contained within meta data or picture parameter set data, PPS, within a data delivery set data.

As part of step 505 a determination may be performed as to whether the data encoded within the token is unique.

Further, as part of the local token processing 503, the kiosk may also call a Bag Token register application to determine whether or not the token has previously been processed.

This may be performed by storing in a SITA register 601 one or more of the data elements shown in Table 1. In one specific example, data defining a flight number, a flight date and Licence Plate Number, LPN may be stored in the register 601. This may allow for a bag token to be uniquely identified. A Flag may also be stored in the database. The flag may indicate whether or not the bag token has previously been used. By checking the flag which matches a particular entry in the register 601, the kiosk 102 may determine whether or not the bag token has previously been used.

If any one or more of the checks are passed successfully, the Bag Tag Kiosk 102 may generate, at step 507 one or more print commands comprising the data extracted from the bag token 100 in order to generate a bag tag 801, 803. This kiosk 102 may then print a physical hardcopy of the bag tag 801, 803. The bag tag 801, 802 may be formatted according to a printing format, such as PECTAB. One or more different PECTAB formats may be stored in a storage means or hard disc associated or provided on the kiosk 102, which may be associated with different providers or airlines. By selecting a format which is associated with a particular airline, the correct print layout may be provided. As will be apparent from FIG. 4 of the drawings, the bag tag token 801, 803 usually comprises any one or more of the data elements shown in Table 1 below. This may be presented in a human readable form and a machine readable form with some data encoded in a format which is only machine readable.

The Bag Tag Kiosk 102 then updates the token at step 509 and notifies the bag token register that the bag token has been processed by storing one or more of the data elements shown in Table 1 below in the register 601, as well as a flag which indicates that a particular bag token 100 has been used.

This data stored in the register 601 may be shared with other kiosks so that the same token may not be used multiple times at different kiosks.

If one or more of the check steps described above in steps 503 and 505 are not affirmative, steps 505, 507, 509, and 601 may be skipped. In response, a processing error is identified at step 511. At step 513, an exception message may be displayed. Finally, the process at the airport bag tag kiosk 102 ends at step 515. The process may be then repeated for another customer.

For the sake of completeness, the airport bag drop process performed at the airport bag drop area 105 will now be described.

Customers attach the bag tag to their luggage and proceed to Bag Drop positions. The customer then identifies themselves by scanning their boarding passes and/or other means of identification, e.g. airline loyalty cards, passports, biometrics, etc. The DCS confirms the PNR. IN other words, the PNR checks that the customer has completed flight check-in and has bag tags allocated. Customers submit their tagged luggage items. The Bag Drop 111 interacts with the DCS 10 to confirm that the detected bag tag has been issued by the DCS.

Once that is confirmed, the Bag Drop performs a range of prescribed checks on the item, regarding its dimensions, weight, presence of prohibited substances, etc. If all checks are passed successfully, the Bag Drop promotes the item into the Baggage Handling System (BHS) and at the same time notifies the DCS that the item has been accepted into custody. The DCS internally marks the BT as “active” and dispatches Baggage Handling Messages (BHM) to all stations along the route of the journey, instructing them how the item should be routed.

Further description of the data encoded within the token 100, also referred to as the Data Delivery Set will now be provided. As noted above, usually, the Data Delivery Set (DDS) is embodied in the form of a 2 dimensional barcode 100.

Once the bag tags have been issued at step 303 by the airline, the DCS perceives that the bag tag(s) to have been printed. In fact, however, the web check-in application 101 captures the bag tag(s) data received from DCS in a structured message and delivers the structured message to the user, which may be in the form of a 2D-barcode, also referred to as a token. In some embodiments, such as the boarding passes 703, 705, 707 shown in FIG. 3 of the drawings, since conventional boarding passes may contain 2D-barcodes, it is important to clearly distinguish these from the bag token 100. For example, this may be achieved by placing the token within a contour of a suitcase.

Also, for example, a barcode symbology (e.g. Aztec) different from those used in boarding passes (e.g. PDF417 and QR) can help avoid the confusion. Alternatively, instead of the bag token being provided within the boarding pass 703, 705, 707, it may be provided in a separate format or document.

The data encoded in the token 100 may comprise any one or more of the data elements shown in Table 1 below. The data may comprise configurable data associated with a particular airline such as data defining a particular format of the token to be produced. The data can, for example, be a concatenation of data elements, such as that shown in the specific example overleaf in Table 1:

TABLE 1
Exemplary structure of data encoded within a token embodying the invention.

| | | Repeating Per-Sector | | Repeating Per Sequential | |
|---|---|---|---|---|---|
| Non-Repeating | | of The Journey | | Group of LPN's | |
| | Size | | Size | | Size |
| Element | (ch) | Element | (ch) | Element | (ch) |
| 32-bit Verification code | 8 | Origin port | 3 | Starting LPN | 10 |
| Version 0 . . . 63 info | 1 | Destination port | 3 | Number of tags | 2 |
| (0 . . . 15- format & | | | | | |
| 0 . . . 3-signature code) | | | | | |
| Issuing airline | 2 | Airline code | 2 | | |
| Date of issue (at GMT) | 4 | Flight number | 5 | | |
| Airport & terminal of | 4 | Date and Month | 5 | | |
| departure | | | | | |
| Booking reference, or PNR | 6 | | | | |
| Priority attributes | 1 | | | | |
| designator | | | | | |
| Customer SQNR | 3 | | | | |
| Number of sectors (1-4) | 1 | | | | |
| Number of LPN sequences | 1 | | | | |
| (1-3) | | | | | |
| Customer name | 15 | | | | |
| Length of [Field-A] (in | 1 | | | | |
| duplets) | | | | | |
| Total non-repeating | 47 | Total per sector | 18 | Total per group | 12 |
| Optional Discretionary | 0-18 | | | | |
| Field-A | | | | | |
| Optional Discretionary | 0- . . . | | | | |
| Field-B | | | | | |

Further, the above data may be encoded within a chip and Near Field Communications may be used to transfer the information to a kiosk, terminal or unit for printing a token.

The above data may be defined in a “For Individual Airline Use” field of the boarding pass, as previously described.

The specific data values for the data elements, also referred to as keys, shown in Table 1 may be in communicated as key-value pairs. The values may be an alpha-numeric string.

For example, an identifier or Licence Plate Number, LPN shown in table 1 above may comprise a bag tag number, such as YY159265 (805) or YY159266 (807) shown in FIG. 4. The letters “YY” may define a particular airline according to a first format. For example, “BA” may be associated with British Airways. “AA” may be associated with American Airlines. Similarly “EK” may be associated with Emirates.

The Licence Plate Number generally includes an airline code according to a further format of 0XXX where “XXX” represents a particular airline in alpha-numeric format. For example, “125” may be associated with British Airways. “001” may be associated with American Airlines. “176” may be associated with Emirates.

The Licence Plate Number may be a concatenation of the airline code according to the further format and the bag tag number.

In one specific example, the 2 leading digits of the bag tag number such as “YY” are removed and then the licence plate number may be generated by concatenating the Airline code “0XXX” and bag tag number “159265” or “159266” with two leading digits “YY” removed. The leading digit “0” may also be relevant because an airline may use it to determine value.

Thus, it will be appreciated that once the starting LPN has been defined and the number of further tokens has been specified, unique bag tag identifiers may be generated for all bags by concatenating an airline code such as “0176” with an bag tag number “159265”. This allows the kiosk 105 to generate bag tag identifiers of EK159265 and EK159266 from a single starting licence plate number or starting licence plate number.

The issuing airline may be defined according to the first format using the “Issuing Airline” syntax element shown in table 1. The “Date of issue (at GMT)” syntax element may be defined according to the string “2205” which may indicate that the token 100 was issued on 22 May. The “Airport & terminal of departure” syntax element may be defined with an associated value having a size of 4 according to the format “PER4”, where PER is associated with Perth Airport, and “4” indicates that the flight is from Terminal 4. The “Booking reference or Passenger Name Record” syntax element may be defined with an associated value having a size of 6 in the format of a six digit number. The “Customer name” syntax element may be defined as an alpha numeric string which may be 15 characters long. The “Origin port” syntax element may have a length of 3 and may be defined according to a format “PER” which is associated with Perth airport. The “Destination port” syntax element may have a length of 3 and may be defined according to a similar format such as “SYD” which is associated with Sydney airport. The “Airline code” syntax element may be defined in a similar manner to the “Issuing airline” syntax element. The “Flight number” syntax element value may have a length of 5 characters according to a format such as “QF580” operated by Quantas. The “Date and month” syntax element value may have a length of 5 characters according to a format “22 May” which indicates that the departure date.

The starting licence plate number may be generated by the departure control system 103 in response to a request from customers mobile device during the web check in stage. This allows the for the pre-generation of the bag tag numbers or the licence plate number in advance of when the bag tags are generated or printed.

Further description of the kiosks, 102, also referred to as a Physical Printing Set (PPS) implementation device will now be provided.

Airports wishing to benefit from the Invention deploy PPS capable kiosks (and or other work stations such as Staff Tablet Computers) in vicinity of Bag-Drop positions.

The following description describes how the airport bag tag kiosk 102 or Physical Printing Set device uses the generated bag token to generate one or more further tokens or bag tags. Usually, this step is performed at the airport by a passenger or customer who has the above bag token as a printed document or stored on a portable device, such as a portable computing device or mobile communications device.

Usually, the kiosk comprises an optical scanner or reader and a bag-tag printer. A user interface in the form of one or more screens may optionally be provided. The screen may guide the user through the bag tag printing process and may also display of error messages.

If a number of kiosks, also referred to as PPS stations within an airport terminal are provided, then they may require a means to exchange information with each other, which may be in the form or wired or a wireless LAN, a Bluetooth network or communications network. However, because of the specific information contained within the DDS data, there is no need to connect these stations to an external network.

A token may be coded or encoded with data. The or a token may be used with or presented for goods or services. The token may be used in exchange for goods or services. The token may be exchanged for goods and services. The skilled person will appreciate that a token may be presented for goods or services, rather than necessarily being exchanged for goods or services. In some examples, the token is a voucher, coupon which may be exchanged for or presented for goods and services. The token is usually a label or descriptive label which may be physically printed. However, physical printing of a token is not essential since data may be coded in an electronic form by being displayed on a display or other means using an electronic bag tag.

Firstly, a customer with luggage arrives at an airport and is directed to a suitable kiosk or station. Using the scanner, the customer scans the bag token or in other words the DDS barcode or token.

When a bar-code is scanned, a PPS controller first assesses whether it is likely to represent a valid and acceptable DDS record. The assessment step may comprise any one or more of determining that:
The symbology of the barcode must belong to the list of enabled ones;
The regular expression patterns for fields must be matched (e.g. the Verification Code must be a sequence of 8 hexadecimal digits, the License Plate must be a sequence of 10 decimal digits, etc.) and all mandatory fields must be non-blank;
The Airport & Terminal of Departure must match the location of the PPS station;
The Date of Issue must be within a proper range from the current date, and
The Issuing Airline must be configured and enabled.

Barcodes failing any of these clauses may be disregarded. An error message to the user and/or an alert to staff may or may not be issued.

The PPS controller then verifies the integrity and authenticity of the record by checking the digital signature, i.e.:
Strips the 8 leftmost characters of the scanned record,
Performs XOR operation on the remaining string and the encryption code configured for the issuing airline,
Calculates CRC32 check-sum on the result and
Compares the check-sum with the Verification Code contained in the 8 leftmost characters of the scanned record.

A match confirms that the record has been signed by an authorised application and delivered correctly. Failure may cause further processing of the barcode to be aborted with or without reporting to the user and/or staff. The last inspection is that the record has not been processed yet. If it has, processing will be terminated with or without reporting to the user and/or staff. The PPS station prints the specified number of bag tag(s) according to the data obtained from the barcode. The PPS station forms a record descriptor by extracting a non-private record descriptor (e.g. a concatenation of Verification Code, Airline Code and Date of Issue), adds it to the list of processed records and also sends it to its piers within the terminal, so no double-printing takes place.

Once the bag tag or tags have been printed, the passenger can collect them and attach them to the appropriate bag(s). This process is referred to a Self-Tagging and is usually performed after a passenger has performed self check-in. Usually, during the self-check in process, the passenger registers for a journey and obtains a boarding pass. Airport Self-Tagging allows the passenger to use a Bag-Drop facility to hand-over their baggage into the custody of the airline.

The only things which may be configured for use by a particular airline are:

1. The encryption code shared with the web application and used for signing the record and

2. The airline logo to be printed on the bag-tag(s).

Multiple different PECTAB formats may be stored on each kiosk, where each airline has a different PECTAB format associated with it.

It will be appreciated that the system is secure because the Verification Code provides protection against the abuse of the system by unmotivated malevolent attacks.

From the foregoing, it will be appreciated that the system, device and method may include a computing device, such as a desktop computer, a laptop computer, a tablet computer, a personal digital assistant, a mobile telephone, a smartphone.

The device may comprise a computer processor running one or more server processes for communicating with client devices. The server processes comprise computer readable program instructions for carrying out the operations of the present invention. The computer readable program instructions may be or source code or object code written in or in any combination of suitable programming languages including procedural programming languages such as C, object orientated programming languages such as C#, C++, Java, scripting languages, assembly languages, machine code instructions, instruction-set-architecture (ISA) instructions, and state-setting data.

The wired or wireless communication networks described above may be public, private, wired or wireless network. The communications network may include one or more of a local area network (LAN), a wide area network (WAN), the Internet, a mobile telephony communication system, or a satellite communication system. The communications network may comprise any suitable infrastructure, including copper cables, optical cables or fibres, routers, firewalls, switches, gateway computers and edge servers.

The system described above may comprise a Graphical User Interface. Embodiments of the invention may include an on-screen graphical user interface. The user interface may be provided, for example, in the form of a widget embedded in a web site, as an application for a device, or on a dedicated landing web page. Computer readable program instructions for implementing the graphical user interface may be downloaded to the client device from a computer readable storage medium via a network, for example, the Internet, a local area network (LAN), a wide area network (WAN) and/or a wireless network. The instructions may be stored in a computer readable storage medium within the client device.

As will be appreciated by one of skill in the art, the invention described herein may be embodied in whole or in part as a method, a data processing system, or a computer program product including computer readable instructions. Accordingly, the invention may take the form of an entirely hardware embodiment or an embodiment combining software, hardware and any other suitable approach or apparatus.

The computer readable program instructions may be stored on a non-transitory, tangible computer readable medium. The computer readable storage medium may include one or more of an electronic storage device, a magnetic storage device, an optical storage device, an electromagnetic storage device, a semiconductor storage device, a portable computer disk, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk.

Exemplary embodiments of the invention may be implemented as a circuit board which may include a CPU, a bus, RAM, flash memory, one or more ports for operation of connected I/O apparatus such as printers, display, keypads, sensors and cameras, ROM, a communications sub-system such as a modem, and communications media.

1. A token (100, 703, 705, 707) for use with an item handling system (109) wherein the token is encoded with data defining a further second token (801) wherein the data comprises an identifier associated with an item for processing by the item handling system.

2. The token (100, 703, 705, 707) according to claim 1 wherein the data defines a plurality of further tokens comprising a third token (803).

3. The token (100, 703, 705, 707) of any preceding claim wherein the data comprises data for independently generating the or each further token (801,803) by a device (102).

4. The token of any preceding claim wherein the data defines the number of further token or tokens and preferably wherein the identifier is a unique identifier.

5. The token of any preceding claim wherein the or each further token is attachable to the item for processing by the item handling system.

6. The token (100, 703, 705, 707) according to any preceding claim wherein the format associated with the token (100) is different from the format associated with the second or/and third tokens (801, 803).

7. The token (100, 703, 705, 707) according to any preceding claim further comprising machine readable data and wherein the further token or tokens (801, 803) comprise both machine readable data and human readable data.

8. The token (100, 703, 705, 707) according to any one of claims 2 to 7 wherein the second token (801) and third token (803) are associated with a different item and preferably wherein the second (801) and third token (803) are associated with a single user or passenger.

9. The token (100, 703, 705, 707) according to any preceding claim wherein the identifier is also associated with the or a user or passenger.

10. The token according to any preceding claim wherein the data encoded within the token (100, 703, 705, 707) comprises an identifier associated with an item of baggage.

11. The token (100, 703, 705, 707) according to any preceding claim wherein the data encoded within the token comprises any one or more of a verification code and data defining an issuing authority associated with the token (100).

12. The token of any preceding claim wherein the data encoded within the token (100, 703, 705, 707) is encoded in an unencrypted format.

13. The token (100, 703, 705, 707) according to any preceding claim wherein the token (100) comprises a two-dimensional code and preferably wherein the second token (801) and preferably the or a third token (803) comprise a two-dimensional format.

14. The token according to any preceding claim wherein the second token (801) and preferably the or a third token (803) are each associated with a format which is different from the format associated with the token (100, 703, 705, 707).

15. The token (100, 703, 705, 707) according to any preceding claim wherein the identifier is a unique identifier and preferably a 12-digit alpha-numeric string comprising any one or more of data defining an airline code and a baggage number and data defining the number of further token or tokens.

16. A boarding pass (703, 705, 707) for use by a passenger comprising the token (100) of any preceding claim.

17. The boarding pass according to claim 16 further comprising a boarding pass barcode, wherein the barcode symbology of the token (100, 703, 705, 707) is different from those used in the boarding pass barcode.

18. The boarding pass according to claim 16 or 17 wherein the token (100, 703, 705, 707) is placed within a profile of an item of baggage encoded on the token.

19. A device (102) for reading data from a token (100, 703, 705, 707) for use with an item handling system (109), the device comprising processing means configured to:
read (501), from the token, data defining a further second token (801) wherein the data comprises an identifier associated with an item for processing by the item handling system; and
generate (507) a second token (801, 803) based on the data read from the token.

20. The device (102) according to claim 19 further comprising reading, from the token, data defining the number of further token or tokens.

21. The device (102) according to any one of claim 19 or 20 wherein the processing means is further configured to generate an identifier associated with a third token from the identifier associated with the second token.

22. The device of claim 19 wherein the processing means is further configured to generate the identifier associated with the third token from the identifier associated with the second token by incrementing the identifier associated with the second token by an integer.

23. The device (102) according to any one of claims 19 to 22 wherein the processing means is further configured to read a verification code from the token (100, 703, 705, 707) and to compare the code to one or more predetermined verification codes.

24. The device (102) according to claim 23 wherein the processing means is further configured to only generate the second or/and third tokens (801, 803) if the verification code read from the token corresponds to one of the predetermined verification codes.

25. The device (102) according to any one of claims 19 to 24 wherein the processing means is further configured to determine whether the second or third tokens (801, 803) have been previously been generated by checking a register (601) and preferably wherein the processing means is further configured to determine whether the register comprises a flag indicative of whether the second or/and third tokens have been previously generated.

26. The device (102) according to claim 25 wherein the processing means is further configured to only generate the second or/and third tokens (801, 803) if the flag indicates that the further token or tokens have not previously been generated.

27. The device according to any one of claims 19 to 26 wherein the data read from the token (100, 703, 705, 707) comprises any one or more of data identifying an airline, data defining a departure date, data defining a departure time.

28. The device according to claim 27 wherein the processing means is further configured to compare the data defining a departure date and departure time to any one or more of a current date and a current time and preferably wherein the processing means only generates the second or/and third tokens if the current date matches the departure date.

29. The device according to any one of claims 19 to 28 wherein the processing means is further configured to store a flag in a storage means, wherein the flag is indicative that the second or/and third tokens (801, 803) have been generated.

30. The device according to claim 29 wherein the flag is associated with data which uniquely identifies that the second or/and third tokens have been generated and preferably wherein the data comprises any one or more of a flight number, a date and licence plate number associated with the item.

31. The device according to any one of claims 19 to 30 wherein the processing means is further configured to generate a print command to print the second or/and third token (801, 803).

32. The device according to any one of claims 19 to 31 wherein the processing means is communicatively coupled to a printer for printing the second or/and third token (801, 803).

33. The device according to any one of claims 19 to 32 wherein the identifier is a unique identifier and preferably a 12-digit alpha-numeric string comprising any one or more of data defining an airline code and a baggage number and data defining the number of further token or tokens and wherein the device is configured to read the unique identifier.

34. The device according to any one of claims 19 to 33 wherein the token is a boarding pass (703, 705, 707) for use by a passenger and wherein the device is configured to read data from the boarding pass.

35. The device according to claim 34 wherein the boarding pass further comprises a boarding pass barcode, wherein the barcode symbology of the token (100, 703, 705, 707) is different from those used in the boarding pass barcode and wherein the device is configured to read data from the boarding pass.

36. The device according to claim 34 or 35 wherein the token (100, 703, 705, 707) is placed within a profile of an item of baggage encoded on the token and wherein the device is configured to read data from the token.

37. A computer processing system (101) for generating data for generating a token (100, 703, 705, 707) for use with an item handling system (109), the data defining a further second token (801, 803), the system comprising processing means configured to:
a. determine data associated with the second token (801, 803), the data comprising an identifier associated with the item for processing by the item handling system; and
b. determine data defining the number of further tokens.

38. The computer processing system of claim 37 further comprising transmission means for transmitting the data to a user device (113) for generating the token (100, 703, 705, 707).

39. The computer processing system (101) according to claim 38 wherein the processing means is further configured to receive a booking reference and preferably validate the booking reference preferably by communicating the booking reference to a departure control system (103).

40. The computer processing system (101) according to any one of claims 37 to 39 wherein the processing means is further configured to receive an indication from a user defining the number of further tokens (801), (803) to be generated.

41. The computer processing system (101) according to any one of claims 37 to 40 wherein the processing means is further configured to generate a request to issue the further tokens (801, 803) and preferably to send the issue request to a departure control system (103).

42. The computer processing system (101) according to any one of claims 37 to 41 wherein the processing means is further configured receive a identifier (805, 807) associated with each further token (801, 803) and preferably further data defining each further token.

43. The computer processing system (101) according to any one of claims 37 to 42 wherein the identifier is a unique identifier and preferably a 12-digit alpha-numeric string comprising any one or more of data defining an airline code and a baggage number and data defining the number of further token or tokens.

44. The computer processing system (101) according to any one of claims 37 to 43 wherein the token comprises a boarding pass (703, 705, 707) for use by a passenger.

45. The computer processing system (101) according to claim 44 wherein the boarding pass comprising a boarding pass barcode, and wherein the barcode symbology of the token (100, 703, 705, 707) is different from those used in the boarding pass barcode and wherein the system is configured to read data from the boarding pass.

46. The computer processing system (101) according to 44 or 45 wherein the token (100, 703, 705, 707) is placed within a profile of an item of baggage encoded on the token and wherein the computer processing system (101) is configured to read data from the token.

47. A communication device (113) comprising processing means configured to:
i. determine user data associated with a record in a computerised reservation system;
ii. transmit the user data to the computerised reservation system; and
iii. receive data defining a token (100, 703, 705, 707) for use with an item handling system (109) wherein the data comprises data defining a further second token (801, 803).

48. The communication device (113) according to claim 47 wherein the data comprises an identifier associated with an item for processing by an item handling system and preferably data defining the number of further tokens.

49. The communication device (113) according to claim 47 or 48 wherein the processing means is further configured to:
i. encode (219) the token (100, 703, 705, 707) with the data defining a second token (801).

50. A method for generating a token comprising the steps of any one of claims 19 to 49.

51. A computer program product which when executed undertakes the method of claim 50.
